(19) United States
(12) Patent Application Publication
(10) Pub. No.: US 2006/0064328 A1
(43) Pub. Date: Mar. 23, 2006

(54) System and method for utilizing a DICOM structured report for workflow optimization

(76) Inventors: Debarshi Datta, Old Bridge, NJ (US); Steven F. Owens, Denville, NJ (US)

Correspondence Address: Siemens Corporation;Intellectual Property Department, 170 Wood Avenue South, Iselin, NJ, 08830, US

(21) Appl. No.: 11/210,536

(22) Filed: Aug. 24, 2005

Related U.S. Application Data
(60) Provisional application No. 60/606,150, filed on Aug. 30, 2004.

(51) Int. Cl. G06F 19/00; G06Q 10/00; G06F 17/00; G06F 17/21

(52) U.S. Cl. 705/3; 705/2; 715/513; 707/104.1

(57) ABSTRACT

A system and method for utilizing a Digital Imaging and Communications in Medicine (DICOM) structured report (SR) for workflow optimization are provided. A method for providing a DICOM SR in an extensible markup language (XML) comprises: generating the DICOM SR; mapping attribute fields of the DICOM SR to an XML document; defining the XML document as a DICOM SR binary object; and storing the XML document in the DICOM SR.

### CROSS-REFERENCE TO RELATED APPLICATION

This application claims the benefit of U.S. Provisional Application No. 60/606,150, filed Aug. 30, 2004, a copy of which is herein incorporated by reference.

### BACKGROUND OF THE INVENTION

1. Technical Field

The present invention relates to presenting medical information in a structured format, and more particularly, to a system and method for utilizing a DICOM structured report for workflow optimization.

2. Discussion of the Related Art

Most small-scale diagnostic medical imaging modalities such as those used for endoscopy or mammography are stand-alone entities. The output of an endoscopy exam is typically a report that details a patient's demographics, health history, exam record, diagnosis, recommendations and histopathological results. Each constituent of the report is compiled by a separate process (e.g., a verbal exchange with the patient, admission procedure, endoscopy exam, lab results, video clips, etc.) and is brought together to form a single record representing the exam. This record, however, exists by itself and has no automated means of being cross-referenced with an electronic patient record (EPR) or a medical image archive for further analysis.

The majority of reports produced by diagnostic medical imaging modalities are structured. The use of structured forms has been shown to reduce the ambiguity of natural language format reports and enhance the precision, clarity and value of clinical documents. At the technical level, a structured report (SR) is the optimal form of documentation in computerized systems as it allows searching, storage and comparison with similar data elements. Consequently, a Digital Imaging and Communications in Medicine (DICOM) SR has emerged to increase the efficiency of the distribution of information between various specialties such as computed tomography (CT), magnetic resonance imaging (MRI), ultrasound, etc.

The DICOM SR is a document architecture designed for encoding and exchanging information using the DICOM hierarchical structure and services. For example, the DICOM SR introduces DICOM information object definitions (IODs) and services used for the storage and transmission of SRs. The DICOM IODs define data structures that describe information objects of real-world objects (e.g., patients, images and reports) that are involved, for example, in radiology operations. The DICOM services are concerned with storage, query, retrieval and transfer of data.

FIG. 1 illustrates an exemplary DICOM SR 100 consisting of a sequence of nodes called “Content Items” 110 that are linked together via relationships 120. Several exemplary relationships defined by DICOM are: ‘HAS OBS CONTEXT’ where the target conveys an observation context for documentation of the source; ‘CONTAINS’ where the source contains the target; ‘HAS CONCEPT MOD’ which qualifies or describes the concept name of the source; ‘HAS PROPERTIES’ which is a description of properties of the source; ‘HAS ACQ CONTEXT’ where the target describes the condition during data acquisition of the source; ‘SELECTED FROM’ where the source conveys spatial or temporal coordinates selected from the target; and ‘INFERRED FROM’ where the source conveys a measurement or other inference made from the target.

Each content item 110 is represented by a name/value pair. The name refers more precisely to a “Concept Name”, which is defined by a code rather than by free text to facilitate indexing and searching. Any concept name may be represented by a coded entry that uses the following triplet encoding attributes: ‘Code Value’ which is a computer-readable and -searchable identifier, ‘Code Scheme Designator’ which is an identifier of the coding organization and ‘Code Meaning’ in which human-readable text is entered to be displayed.

The value of a content item 110 is typically one of the following: ‘CONTAINER’ for headings or categories; ‘TEXT’ for free form textual expression; ‘PNAME’ for a patient's name; ‘DATETIME’ which is a concentrated date and time of occurrence; ‘DATE’ which is the calendar date of occurrence; ‘TIME’ which is time of day of occurrence; ‘NUM’ for numeric values or measurements with associated units; ‘IMAGE’ for unique identifier (UID) references to image service-object-pair (SOP) instances; ‘WAVEFORM’ for UID references to waveform SOP instances; ‘COMPOSITE’ for UID references to composite SOP instances; ‘UIDREF’ for UIDs identified by concept name; ‘SCOORD’ for spatial coordinates of a geometric region of interest (ROI) in images; ‘TCOORD’ for temporal coordinates of an ROI in waveforms; and ‘CODE’ which is a coded expression of the concept.

As further shown in FIG. 1, a parent content item 110 (e.g., source node) can be linked to a child content item 110 (e.g., target node) with one of the relationships 120 just described. For example, a radiography report of posteroanterior and lateral views of a patient's colon may contain the following finding and conclusion sections: “The finding is a mass measuring 1.3 cm in diameter with an infiltrative margination. The conclusion is a probable malignancy, inferred from the infiltrative margination of the mass.” This report can be represented in a DICOM SR having a document structure 200 as shown in FIG. 2.

Today, the DICOM SR has become a powerful format that improves the expressiveness, precision and comparability of clinical documentation. For example, the DICOM SR provides the capability to link a clinical document to DICOM images and waveforms such that they can be displayed simultaneously at the same workstation. Further, the DICOM SR is a “databaseable document” format that facilitates computer search analysis for various purposes, such as scientific research, education, training, clinical trials, performance evaluation, and eventually for integration with data mining applications.

However, DICOM SRs are not correlated with constituent data therein. Moreover, DICOM SRs are typically only post-examination data holders. Accordingly, there is a need for a technique of creating a comprehensive set of pre- and post-examination medical information for presentation in a report that has intelligent formatting such that this information can be utilized in an efficient manner.

### SUMMARY OF THE INVENTION

The present invention overcomes the foregoing and other problems encountered in the known teachings by incorporating all of the steps of the clinical workflow into a DICOM SR for optimizing the clinical workflow.

In one embodiment of the present invention, a method for providing a DICOM SR in XML comprises: generating the DICOM SR; mapping attribute fields of the DICOM SR to an XML document; defining the XML document as a DICOM SR binary object; and storing the XML document in the DICOM SR.

The method further comprises defining a format for the XML document stored in the DICOM SR by using an XSD. The method further comprises linking the XML document stored in the DICOM SR with a reporting application.

In another embodiment of the present invention, a method for generating a clinical workflow report comprises: receiving pre-examination medical information associated with a patient; generating a DICOM SR associated with the patient; storing the DICOM SR in XML; storing the pre-examination medical information in the DICOM SR stored in XML; receiving post-examination medical information associated with the patient; and storing the post-examination medical information in the DICOM SR stored in XML.

The step of storing the DICOM SR in XML comprises: mapping attribute fields of the DICOM SR to an XML document; defining the XML document as a DICOM SR binary object; and storing the XML document in the DICOM SR.

The method further comprises linking the pre- and post-examination medical information in the DICOM SR stored in XML. The method further comprises providing access to the linked pre- and post-examination medical information in the DICOM SR stored in XML.

The method further comprises storing HL7 and CDA data types in the DICOM SR stored in XML. The method further comprises pre-populating fields of the DICOM SR stored in XML upon receipt of pre- or post-examination medical information.

The method further comprises: receiving a diagnosis based on one of the pre- or post-examination medical information in the DICOM SR stored in XML; and indexing the diagnosis. The method further comprises generating an electronic record associated with the patient and a worklist associated with the patient upon receipt of the pre-examination medical information. The method further comprises archiving the DICOM SR stored in XML.

In yet another embodiment of the present invention, a system for collecting clinical workflow steps for storing in a report comprises: a first server for receiving pre-examination medical information associated with a patient; a first computer for receiving post-examination medical information associated with the patient; a second server coupled to the first server and the first computer for generating a DICOM SR associated with the patient; storing the DICOM SR in XML and storing the pre- and post-examination medical information in the DICOM SR stored in XML; and a report generator coupled to the second server for generating the DICOM SR stored in XML in human-readable form and outputting the human-readable DICOM SR.

When storing the DICOM SR in XML the second server maps attribute fields of the DICOM SR to an XML document; defines the XML document as a DICOM SR binary object; and stores the XML document in the DICOM SR.

The system further comprises: a second computer coupled to one of the first server or the second server for providing the pre-examination medical information; and an acquisition console coupled to the second server for providing the post-examination medical information.

The acquisition console is one of an MRI device, CT imaging device, PET device, 2D or 3D fluoroscopic imaging device, 2D, 3D, or 4D ultrasound imaging device, endoscope, bedside monitor, x-ray device or hybrid-imaging device.

The second server comprises a DICOM image database or a patient database. The first computer is coupled to a medical imaging modality diagnostic tool set.

The second server is coupled to a lab computer for receiving the pre- and post-examination medical information. The report generator is coupled to one of a printer or a display device for presenting the human-readable DICOM SR.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 is a diagram illustrating an entity-relationship in a DICOM SR;

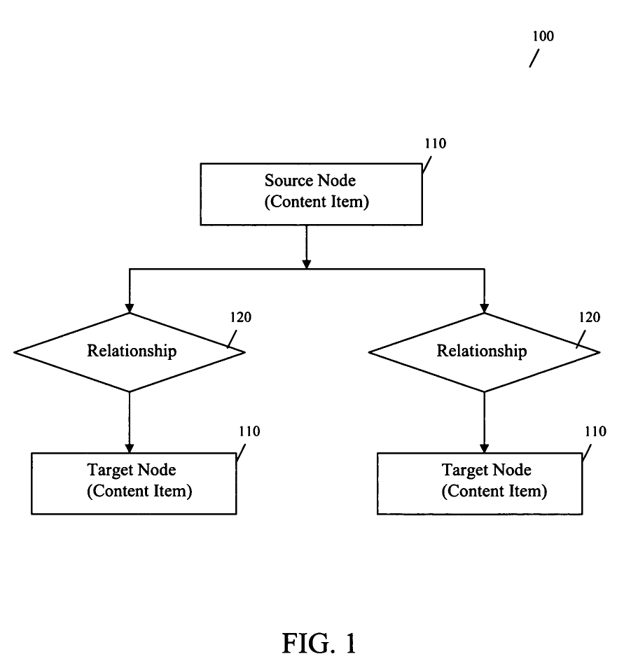

FIG. 2 is a diagram illustrating a document structure of an exemplary DICOM SR;

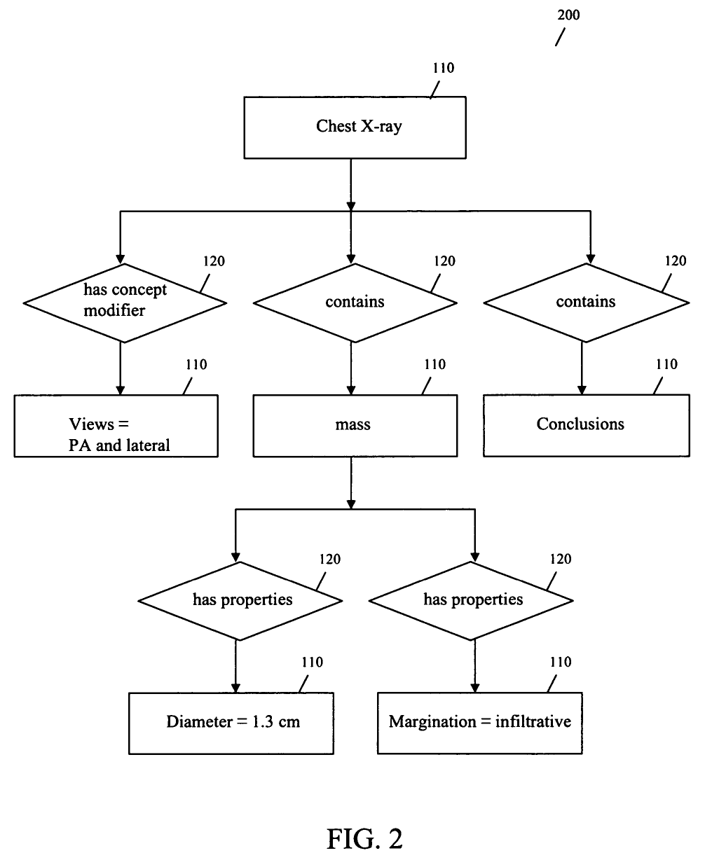

FIG. 3 is a block diagram illustrating a system for utilizing a DICOM SR for workflow optimization according to an exemplary embodiment of the present invention;

FIG. 4 is a flowchart illustrating a method for providing a DICOM SR in XML according to an exemplary embodiment of the present invention; and

FIG. 5 is a flowchart illustrating a method for utilizing a DICOM SR for workflow optimization according to an exemplary embodiment of the present invention.

### DETAILED DESCRIPTION OF EXEMPLARY EMBODIMENTS

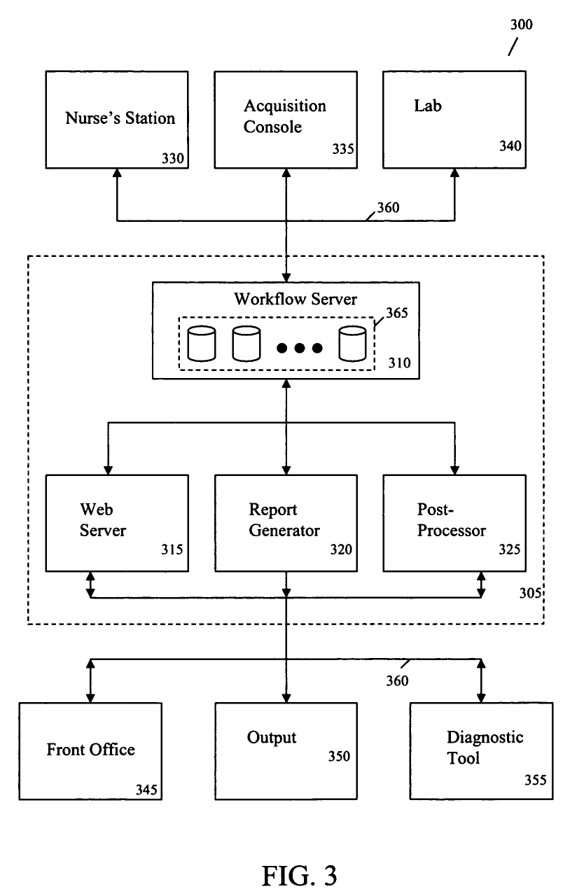

FIG. 3 is a block diagram of a system 300 for utilizing a DICOM SR for workflow optimization according to an exemplary embodiment of the present invention.

As shown in FIG. 3, the system 300 includes a workstation 305 coupled to a variety of ancillary devices such as a nurse's workstation computer 330, an acquisition console 335 and a lab computer 340 over, for example, an Ethernet network 360. The workstation 305 is also connected via the network 360 to a front office computer 345 such as that available at the front desk of a physician's office, an output device 350 such as a printer or display, and a computer 355 employing, for example, a medical imaging diagnostic toolkit.

The acquisition console 335 may be, for example, an MRI device, CT imaging device, helical CT device, positron emission tomography (PET) device, 2D or 3D fluoroscopic imaging device, 2D, 3D, or four-dimensional (4D) ultrasound imaging device, endoscope, bedside monitor, x-ray device or a hybrid-imaging device capable of CT, MR, PET, ultrasound or other imaging techniques. It is to be understood that although only one acquisition console 335 is shown, a variety of acquisition consoles could be coupled to the workstation 305. Further, a variety of ancillary devices such as additional nurse's workstation computers, a technician's workstation computer or external lab computers could be coupled to the workstation 305.

As further shown in FIG. 3, the workstation 305 includes a workflow server 310 coupled to a web server 315 for interfacing the workstation 305 with external devices or applications via the internet, a report generator 320 for generating reports and a post-processor 325. It is to be understood that the workstation 305 could be a stand-alone unit as shown or a combination of devices such as the web server 315, report generator 320 and post-processor 325 connected over a network.

The post-processor 325 is used to process data acquired by the workstation 305 and cross-correlate it, for example, with patient image data that is stored in the computer 355. The post-processor 325 or the computer 355 may include any suitable image rendering system/tool/application that can process digital image data of an acquired image dataset (or portion thereof) to generate and display 2D and/or 3D images. More specifically, the image rendering system may be an application that provides 2D/3D rendering and visualization of medical image data, and which executes on a general purpose or specific computer workstation. Moreover, the image rendering system may enable a user to navigate through a 3D image or a plurality of 2D image slices.

The workflow server 310 may be a DICOM SR server that provides, inter alia, code services and document services. The code services are used to provide an interface to a code database in a set of databases and modules 365 for lexicon and code mapping services. The document services include, for example, document management and document validation. The document management service is used to provide interfaces and services to manage DICOM SR documents and also provides interfaces to Health Level Seven (HL7), clinical document architecture (CDA) and DICOM worklists to assign general rules to DICOM SR documents. The document validation service provides interfaces and services to validate the status and verify DICOM SR documents.

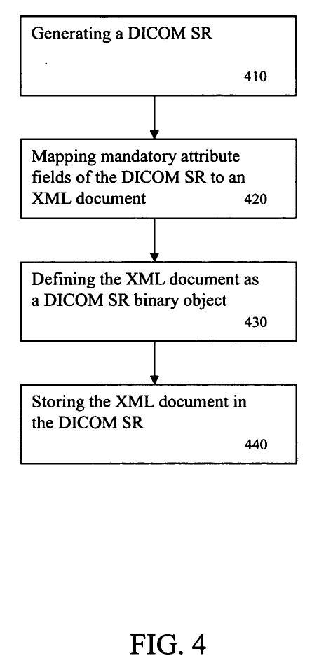

The workflow server 310 is configured to provide DICOM SRs in an extensible markup language (XML). This process will now be described with reference to FIG. 4.

As shown in FIG. 4, a DICOM SR is generated (410). This is accomplished, for example, by receiving information regarding a patient such as that typically acquired prior to an examination, creating an EPR and generating a DICOM SR associated with the patient. Once the DICOM SR has been generated, mandatory DICOM attribute fields (e.g., IODs and SOPs) relating to the patient, the examination to be performed, date of the examination, etc., are mapped (420). In other words, as a basic DICOM SR IOD identifies, for example, the patient, study, series, equipment and document as mandatory information entities, these information entities are filled up (e.g., mapped) by the information contained and to be contained within an XML document. It is to be understood that when mapping the attributes to DICOM databases such as a DICOM image database available in the set of databases and modules 365, the workflow server 310 only exposes the mandatory attributes while maintaining the DICOM SR as an XML document.

After the mandatory attribute fields have been mapped, the XML document is defined as a binary DICOM SR object (e.g., by storing the XML document as a DICOM Composite IQD or as a non-image object in an SR content module) (430). The XML document is then stored in the DICOM SR (440). This process enables various types of reports to be archived because there is no need for a fixed set of fields to limit the contents of the DICOM SR. Further, validation of the reports can be done by using a specified XML schema (XSD). For example, by using an XML schema, a hospital or a physician's office can include their own unique signature on their report.

The above process enables multi-modality workstations, which use the XML schema for identifying modality specific fields, to perform fast searching and lexicon mapping by optimizing the code service based on the XML schema. In addition, data produced in the system 300 and stored in the DICOM SR can be analyzed and displayed using diverse reporting applications compatible with XML and the XML schema being used. Further, access to this information across a variety of platforms independent of the operating systems being used can occur because the XML format of the DICOM SR allows for the easy interchange of documents over the internet or via a common network.

Referring back to FIG. 3, the set of databases and modules 365 of the workflow server 310 may include a DICOM template generator application through which a user can create templates for their own use such as those already created for computer-aided detection (CAD) forms of mammography and echocardiography. For example, the template generator may use conventional DICOM SR template tables and provide visual tools to layout the presentation of the report thus enabling a user to specify certain parameters and equations.

The report generator 320 may use information provided by the template generator, document service, code or patient image database (both of which may be included in the set of databases and modules 365) to generate, display and print a report reflecting the contents of the DICOM SR via the output device 350. The report generator 320 may also include an interface for editing the contents of the report and an interface for printing, exporting and archiving the report. It is to be understood that because the DICOM SR is stored in XML it may be exported into various document formats such as .PDF, Word, .RTF, etc. In addition, in combination with the layout from the template generator, the report generator 320 can enable, for example, “wysiwyg” printing of reports.

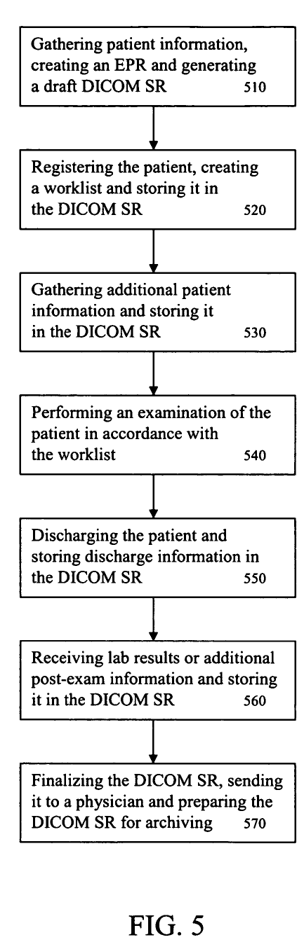

FIG. 5 is a flowchart showing an operation of a method for utilizing a DICOM SR for workflow optimization according to an exemplary embodiment of the present invention.

As shown in FIG. 5, pre-registration occurs as patient information such as the patient's name and medical condition is collected over the phone by an employee of a physician's office (510). At this time, the patient is assigned an EPR (e.g., a patient ID) and a DICOM SR is generated. Once the DICOM SR is generated, it is stored in XML as described above with reference to FIG. 4.

Using the patient's EPR, any data pertinent to the patient may be stored in the DICOM SR. For example, if the time of the patient's appointment for an exam has changed, this information will be stored in the DICOM SR and a worklist (to be discussed below) will be updated accordingly. Now that the patient has been pre-registered, the patient's registration process may continue (520). This typically includes generating the worklist for the patient, which is a set of procedures to be performed on or by the patient and medical staff prior to during and after a medical examination. This worklist is then stored in the DICOM SR.

In accordance with the worklist, the patient is then prepared for their exam. This typically involves a series of preparatory steps such as questioning by the nurse, taking blood-work and signing a variety of waivers among others. As this process takes place, each step is documented and stored in the DICOM SR (530). Once the pre-exam procedures are complete 510, the patient may be examined.

The patient may be examined for a variety of different ailments; however, in this example the patient is given a mammography. The mammography is performed in accordance with the worklist. The data acquired during the patient exam such as ultrasound images or notations regarding potential cancerous findings is stored in the DICOM SR (540). Further, some of this data may be routed to and stored in an image database of the set of databases and modules 365 and then exported to a diagnostic toolkit available on the computer 355. Once the exam is complete, post-examination procedures may take place.

For example, after the exam, the patient is typically discharged by giving the patient a set of discharge instructions and a discharge letter. In addition, the data acquired during the exam may be sent to a lab for analysis. All of this information is stored in the DICOM SR (550). Once the lab has completed their analysis of the data, whether it is medical image data, organic tissue or blood, their findings are sent back to the physician's office. This information is then incorporated into the DICOM SR (560). Additional information such as a radiologist's findings and conclusions regarding the patient's image data may also be incorporated into the DICOM SR.

Upon incorporating the lab results and radiologist's findings and conclusions into the DICOM SR, a proprietary or final report is generated by the report generator 320 (570). Once this report is generated, it may be sent to the patient's physician for their review. For example, it may be sent to the physician in either hard-copy form or in electronic form for display on a computer monitor. After the report has been finalized and reviewed by the physician, it may then be archived and stored either in a database coupled to the workflow server 310 or in the physician's paper or electronic archives.

The finalized DICOM SR includes all of the information from the above steps of the clinical workflow, thus eliminating the need for maintaining a separate archive for each step of the workflow. By storing the workflow information in a single DICOM SR document in accordance with an exemplary embodiment of the present invention, hospitals or medical offices can analyze their clinical workflows to optimize productivity issues. Further, by storing the DICOM SR in XML each report can be customized and workflow parameters can be adjusted according to their needs and desires.

In one variant of the present invention, the pre- and post-exam medical information in the DICOM SR may be linked and the linked pre- and post-exam medical information may be accessed. This is accomplished by keeping the pre- and post-exam medical information in XML format and storing this information in the binary portion of the DICOM SR as discussed above with reference to FIG. 4, thus enabling the pre- and post-exam medical information to be interpreted at each step of the workflow.

For example, if a patient has a routine colon screening and during the course of acquiring colonic images the acquisition system recognizes that two or more tissue samples are taken, a CAD algorithm present in the post-processor 325 can be used to reduce the likelihood that the exam results are “normal”. Further, the duration of the exam or the number of instances of insufflation may also be used to provide guidance or “hints” regarding the colonoscopy results.

In addition, because all the information of the clinical workflow is stored in a single DICOM SR, data in the DICOM SR can be interpreted at each point in time thus enabling information regarding a next step in the workflow to be derived. For example, if a tissue sample is taken during an acquisition, the system could trigger an additional workflow that would generate labels for samples to be sent to a lab. In addition, the system could add sections to the final report where lab results would be reported once received.

The interpretation of data in the DICOM SR at each point in time also enables information to be derived regarding procurement and materials management systems. For example, if the DICOM SR contains information about contrast media used during an exam, the workflow server or engine could trigger an event that causes a check on inventory or automatically order replacement supplies of contrast media.

In another variant of the present invention, fields in the DICOM SR can be pre-populated upon receipt of pre- or post-exam medical information thus enabling a faster time cycle for reporting. In other words, the XML document that forms the DICOM SR is partially filled in each step of the clinical workflow. For example, when an appointment is made, the scheduled appointment time and the reason for the patient's visit are stored in the DICOM SR. When the patient arrives at the point of care center, the registration can continue with the previously entered data already stored in the DICOM SR and the exam room number and admitted diagnosis can be added to the DICOM SR. The subsequent department handling the patient or the patient's DICOM SR can then add onto the already populated report.

In yet another variant of the present invention, a diagnosis of a patient can be received and then indexed. This is accomplished by using a specific tag for a disease code in the XML document that forms the DICOM SR. This tag can be queried, cross-referenced and filtered by any system compatible with XML. Thus, CAD systems can parse the DICOM SR for specific pointers to enable CAD systems to rapidly produce a prognosis.

It is to be further understood that the present invention may be implemented in various forms of hardware, software, firmware, special purpose processors, or a combination thereof. In one embodiment, the present invention may be implemented in software as an application program tangibly embodied on a program storage device (e.g., magnetic floppy disk, RAM, CD ROM, DVD, ROM, and flash memory). The application program may be uploaded to, and executed by, a machine comprising any suitable architecture.

It is to be further understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

It should also be understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention.

It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A method for providing a Digital Imaging and Communications in Medicine (DICOM) structured report (SR) in an extensible markup language (XML), comprising:
generating the DICOM SR;
mapping attribute fields of the DICOM SR to an XML document;
defining the XML document as a DICOM SR binary object; and
storing the XML document in the DICOM SR.

2. The method of claim 1, further comprising:
defining a format for the XML document stored in the DICOM SR by using an XML schema definition (XSD).

3. The method of claim 1, further comprising:
linking the XML document stored in the DICOM SR with a reporting application.

4. A method for generating a clinical workflow report, comprising:
receiving pre-examination medical information associated with a patient;
generating a Digital Imaging and Communications in Medicine (DICOM) structured report (SR) associated with the patient;
storing the DICOM SR in an extensible markup language (XML);
storing the pre-examination medical information in the DICOM SR stored in XML;
receiving post-examination medical information associated with the patient; and
storing the post-examination medical information in the DICOM SR stored in XML.

5. The method of claim 4, wherein the step of storing the DICOM SR in XML comprises:
mapping attribute fields of the DICOM SR to an XML document;
defining the XML document as a DICOM SR binary object; and
storing the XML document in the DICOM SR.

6. The method of claim 4, further comprising:
linking the pre- and post-examination medical information in the DICOM SR stored in XML.

7. The method of claim 6, further comprising:
providing access to the linked pre- and post-examination medical information in the DICOM SR stored in XML.

8. The method of claim 4, further comprising:
storing health level seven (HL7) and clinical document architecture (CDA) data types in the DICOM SR stored in XML.

9. The method of claim 4, further comprising:
pre-populating fields of the DICOM SR stored in XML upon receipt of pre- or post-examination medical information.

10. The method of claim 4, further comprising:
receiving a diagnosis based on one of the pre- or post-examination medical information in the DICOM SR stored in XML; and
indexing the diagnosis.

11. The method of claim 4, further comprising:
generating an electronic record associated with the patient and a worklist associated with the patient upon receipt of the pre-examination medical information.

12. The method of claim 4, further comprising:
archiving the DICOM SR stored in XML.

13. A system for collecting clinical workflow steps for storing in a report, comprising:
a first server for receiving pre-examination medical information associated with a patient;
a first computer for receiving post-examination medical information associated with the patient;
a second server coupled to the first server and the first computer for generating a Digital Imaging and Communications in Medicine (DICOM) structured report (SR) associated with the patient; storing the DICOM SR in an extensible markup language (XML) and storing the pre- and post-examination medical information in the DICOM SR stored in XML; and
a report generator coupled to the second server for generating the DICOM SR stored in XML in human-readable form and outputting the human-readable DICOM SR.

14. The system of claim 13, wherein when storing the DICOM SR in XML the second server maps attribute fields of the DICOM SR to an XML document; defines the XML document as a DICOM SR binary object; and stores the XML document in the DICOM SR.

15. The system of claim 13, further comprising:
a second computer coupled to one of the first server or the second server for providing the pre-examination medical information; and
an acquisition console coupled to the second server for providing the post-examination medical information.

16. The system of claim 15, wherein the acquisition console is one of a magnetic resonance imaging (MRI) device, computed tomography (CT) imaging device, postion emission tomography (PET) device two-dimensional (2D) or three-dimensional (3D) fluoroscopic imaging device, 2D, 3D, or four-dimensional (4D) ultrasound imaging device, endoscope, bedside monitor, x-ray device or hybrid-imaging device.

17. The system of claim 13, wherein the second server comprises a DICOM image database or a patient database.

18. The system of claim 13, wherein the first computer is coupled to a medical imaging modality diagnostic tool set.

19. The system of claim 13, wherein the second server is coupled to a lab computer for receiving the pre- and post-examination medical information.

20. The system of claim 13, wherein the report generator is coupled to one of a printer or a display device for presenting the human-readable DICOM SR.
